(19) United States
(12) Patent Application Publication
(10) Pub. No.: US 2006/0283729 A1
(43) Pub. Date: Dec. 21, 2006

(54) MAILER AND STORAGE PACKAGE

(75) Inventor: Arnold F. Feffer, Morton Grove, IL (US)

Correspondence Address: WELSH & KATZ, LTD, 120 S RIVERSIDE PLAZA, 22ND FLOOR, CHICAGO, IL, 60606, US

(73) Assignee: QUANTUM COLOR GRAPHICS, Inc., Morton Grove, IL (US)

(21) Appl. No.: 11/379,211

(22) Filed: Apr. 18, 2006

Related U.S. Application Data
(60) Provisional application No. 60/673,255, filed on Apr. 19, 2005.

(51) Int. Cl. B42D 15/00; B65D 71/00; B65D 85/30

(52) U.S. Cl. 206/232; 206/312; 229/87.01; 229/92.8

(57) ABSTRACT

A fold-over cover holder for mailing and storing a compact disc or the like is made from a unitary die-cut blank that defines panels adapted to be folded and selectively secured in juxtaposed relation to create an inside pocket for holding a compact disc. A cover panel is adapted to be sealed in overlying relation to the pocket so as to close the inside pocket for mailing. The recipient can open the cover by bursting a perforation line adjacent the tape strip. Once opened, a tab is exposed on the cover that, when inserted into a pre-cut slot on the pocket, securely closes the cover so that the package can be retained to store the compact disc. A die cut opening is formed in the pocket forming panel to display the stored disc when the cover panel is opened.

This application claims the benefit of U.S. Provisional Application Ser. No. 60/673,255, filed Apr. 19, 2005, which is incorporated herein by reference and relates generally to mailing and storage packaging, and more particularly to a mailer and storage package formed from a single sheet die-cut blank and which finds particular application in mailing relatively flat thin articles, such as a DVD format disc, a compact disc, commonly termed a “CD”, and the like, and wherein the recipient can readily convert the mailer for storing the mailed article.

### BACKGROUND OF THE INVENTION

### Field of the Invention

It is known to provide packaging for compact discs, commonly referred to as “CD's”, that facilitate both mailing and subsequent storage of the CD's. Such packaging is generally made from die-cut blanks having fold lines defining flaps and panels that can be folded to establish an internal disc receiving pocket. Such packaging may take the form of relatively simple compact disc packages, such as disclosed in U.S. Pat. No. 5,662,217 to Durr and U.S. Pat. No. 6,494,319 to Collins, or a more detailed CD case as disclosed in U.S. Pat. No. 5,101,973. The present invention provides an economic compact CD mailer that can be readily converted by the recipient to a CD storage package.

### SUMMARY OF THE INVENTION

A general object of the present invention is to provide a mailing and storage package for a compact disc (CD) which is formed from a unitary die-cut blank having selective fold and perforation lines that facilitate ease of folding into a compact package.

A more particular object of the invention is to provide a fold-over holder or package for mailing and storing a compact disc that is made from a die-cut blank defining three aligned generally rectangular panels and having fold and perforation lines that enable end panels to be folded about transverse fold lines with one end panel cooperating with inwardly folded side flaps on the middle panel to establish a disc receiving pocket, and the other end panel being folded to overlie and close the disc pocket for mailing the packaged disc. The outer surface of the blank may be printed with indicia that facilitates placement of sender and addressee identification.

Another object of the invention lies in providing a generally rectangular die-cut blank defining three generally rectangular aligned panels interconnected by transverse fold lines and being selectively foldable to lie in juxtaposed relation. The middle panel has laterally opposed flaps foldable to overlie the middle panel and have free edges that cooperate to establish lateral boundaries of an inside pocket to receive a compact disc. One end panel is foldable to overlie the middle panel and define part of the disc receiving pocket. The other end panel defines a cover that is foldable to overlie the first folded end panel and is adapted to be sealed in a closed position for mailing but can be opened by a recipient by bursting a perforation line to expose a tab on the cover for insertion into a pre-cut slot adjacent the disc pocket for storing a compact disc.

Further objects, features and advantages of the present invention will become apparent from the following detailed description taken with the accompanying drawings wherein like reference numbers represent like elements throughout the several views. While the present invention is susceptible of embodiments in various forms, there is shown in the drawings a presently preferred embodiment that is described in the following description. It should be understood that the present disclosure is to be considered as an exemplification of the present invention, and is not intended to limit the invention to the specific embodiment illustrated and described.

### BRIEF DESCRIPTION OF THE DRAWINGS

FIG. 1 is a plan view of a mailer and storage package constructed in accordance with the invention for mailing and subsequent storage of a relatively flat thin article such as a compact disc, the mailer being shown in a closed mailing mode with a disc disposed within the mailer;

FIG. 2 is a perspective view of the mailer and storage package of FIG. 1 with the cover panel being shown in an open position prior to use as a mailer;

FIG. 3 is a plan view of the mailer and storage package of FIG. 1 but with cover panel open to expose the disc receiving pocket, portions of the end panel that forms part of the disc receiving pocket being broken away for clarity;

FIG. 4 is a plan view of the unitary blank from which the mailer and storage package of FIGS. 1-3 is formed;

FIG. 5 is a plan view of the opposite side of the single piece blank of FIG. 4;

FIG. 6 is a plan view of a CD format compact disc representative of the type of article that can be mailed and subsequently stored in the mailer and storage device of FIGS. 1 and 2; and

FIG. 7 is a plan view of a transparent protective cover to receive the compact disc prior to placement in the disc receiving pocket in the mailer and storage package of FIGS. 1 and 2.

### DETAILED DESCRIPTION

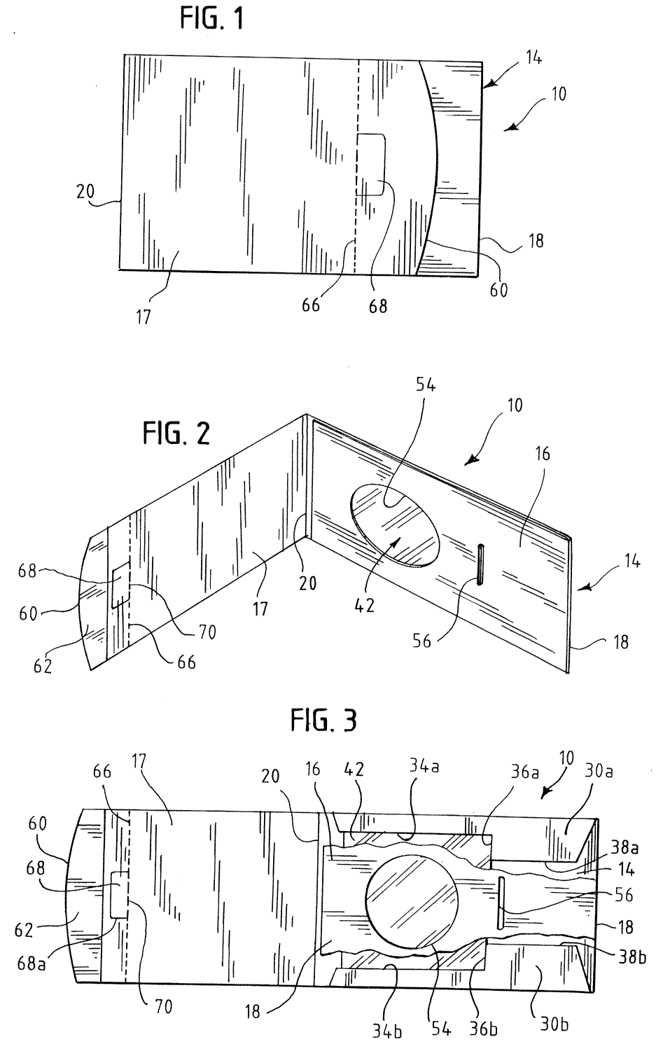

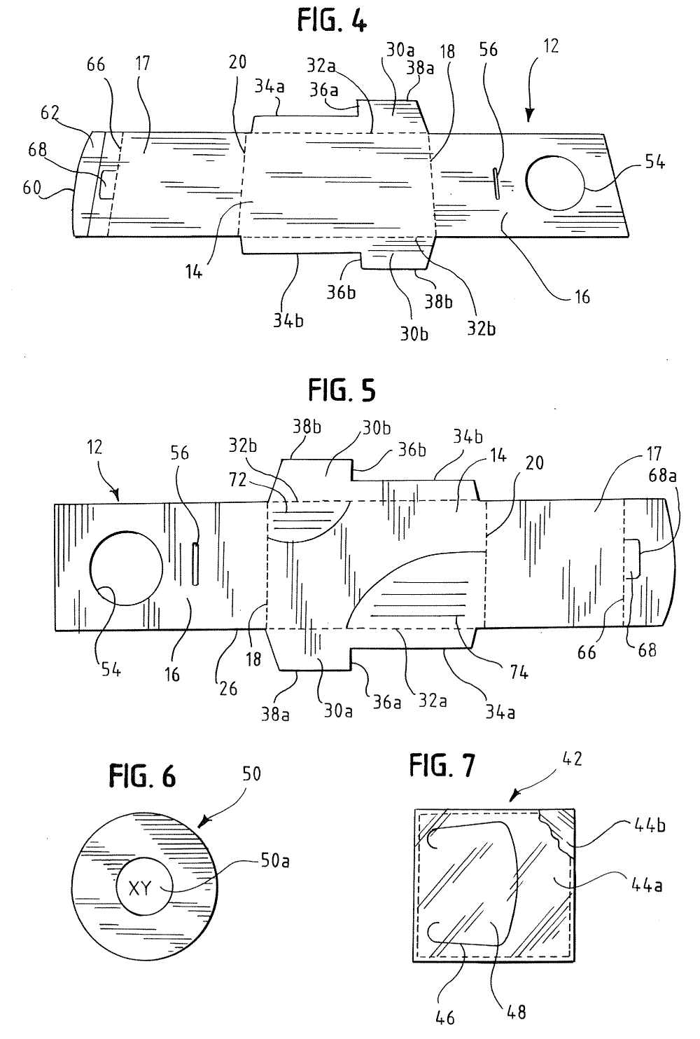

Referring to FIGS. 1-3, a mailer and storage package for use in mailing a relatively flat thin article, such as a compact disc, commonly termed a “CD”, or the like, and wherein the recipient can readily convert the mailer for storing the mailed article, is indicated generally at 10. The mailer and storage package 10 is formed from a unitary die-cut blank, indicated generally at 12 in FIGS. 4 and 5, that defines a middle panel 14 and aligned end panels 16 and 17 which when selective folded and secured, create a compact disc receiving and support pocket for mailing and subsequent storage of a compact disc. The middle panel 14 and end panel 16 are mutually interconnected at a transverse fold line 18 so that the cover panel 16 may be folded between an open positioned generally coplanar with the middle panel 14, alternatively termed the article receiving and support panel, as shown in FIG. 3, to a closed position overlying the middle panel for use as a mailing package as illustrated in FIG. 1. The die-cut blank 12 is dimensioned so that when assembled into the mailer and storage package 10, a mailing package is created having a longitudinal length of approximately 7 inches and a transverse width of approximately 4 inches, the thickness of the mailing package being within the requirements of the postal service.

While the following described embodiment of the mailer and storage device 10 is described for use with a relatively thin article, such as a mini DVD format disc, it will be understood that the invention is equally applicable to other discs shaped articles, such as computer floppy discs and the like, and that the mailer could be used with articles of different peripheral configurations than circular.

Referring again to FIGS. 4 and 5 taken in conjunction with FIGS. 1-3, the unitary or single piece blank 12 is generally rectangular in plan configuration and is preferably made from a 16 pt (thickness) SBS (solid bleach stock, a type of cardboard stock that is premium grade C1 S (coated one side). The coated side of the blank from which the mailer and storage package is made is then printed and the sheet is die cut to create openings in the various panels as will be described.

The middle panel 14 has a pair of substantially identically shaped longitudinally extending and laterally opposed flaps or wing members 30a and 30b which secured to the laterally opposite marginal edges of the middle panel and foldable about fold lines 32a and 32b, respectively, that define the longitudinal marginal edges of the middle panel. The flaps or wing members 30a,b are foldable so as to lie in overlying relation against the surface of the middle panel 14, as illustrated in FIG. 3. When the end panel 16 is folded about the fold line 18 to overlie the middle panel 14, the flaps or wing members 30a,b are captured between the middle and end panels. During forming of the die cut blank into the mailer and storage package 10, a double sided adhesive tape is applied along the upper exposed surfaces of the wing members 30,b so that when the end panel 16 is folded to overlie the middle panel, the lateral edges of the end panel 16 are adhesively secured to the wing members to form an open ended disc receiving pocket.

The wing members 30a,b are formed during the die cut operation to create longitudinal marginal edges 34a and 34b, respectively, that intersect right angle edges 36a and 36b which in turn intersect longitudinal marginal edges 38a,b on the wing members. The wing members are sized so that when the folded about the fold lines 32a and 32b to engage the middle panel 14, the marginal edges 34a,b and 36a,b establish the marginal boundary of a rectangular pocket adapted to receive a rectangular transparent disc protecting cover as illustrated generally at 42 in FIG. 7.

The disc receiving cover 42 is preferably made of a flexible thin transparent plastic material having matching rectangular sides 44a and 44b that are suitably secured together at their peripheral edges as by heat sealing or the like. The side 44a of the disc receiving cover has a suitable slit 46 formed therein which establishes a flap 48 of a size to enable insertion of a circular disc, such as indicated at 50 in FIG. 6, having a disc identifying label 50a generally centrally thereon. The disc 50 represents a mini DVD format disc to be mailed and subsequently stored in the mailing and storage package 10.

In die cutting the unitary blank 12, a circular opening or window 54 is preferably die cut in the end panel 16 so that the window overlies the disc receiving pocket and exposes the label on the disc in the disc receiving pocket. A transverse slot 56 is also die cut in the end panel 16 for a purpose to be described.

The die cut end panel 17 is also generally rectangular but has a longitudinal length less than the longitudinal length of the middle panel 14 so that a curved marginal edge 60 on end panel 17 is spaced from the fold line 18 when the cover panel is in a folded closed position as shown in FIG. 1. To facilitate releasable attachment of the end cover panel 17 in overlying relation to folded end panel 16, an adhesive is applied to an upper surface area on the free end of the end panel 17 and covered by a suitable removable cover 62. The cover 62 can be removed to expose the adhesive area of the end panel 17 for releasably securing the end panel in closed relation against the folded end panel 16 for mailing.

A feature of the mailer and storage package 10 is the ability to convert the mailer to a storage package after the recipient has opened the mailer to access the disc or other flat article carried within the article receiving pocket. To this end, the cover panel 17 opposite the transverse fold line 18 is provided with a pair of transverse aligned tear lines 66. The tear lines 66 extend from the longitudinal marginal edges of the end panel 17 to a rectangular tab 68 that is defined by a U-shaped severed or cut line 68a. When the recipient of the mailed compact disc wishes to open and expose the disc pocket, the recipient grasps the cover end panel to sever it along the tear lines 66 and cut line 68a thereby leaving the rectangular tab 68 exposed for bending about a bend line 70. After thus severing the adhesive end of the end panel 17 and freeing the end panel for exposing the disc receiving pocket, the cover end panel 17 may again be folded about the fold line 18 and the tab 68 can be inserted into the slot 56 to releasably retain the cover end panel in a closed position with a disc or other article disposed within the disc receiving recess for storage.

As aforedescribed, the blank 12 is preferably made from a 16pt thickness of solid bleach stock coated on one side to facilitate printing on the coated side, preferably before die cutting the circular window 54 and slot 56 in the end panel 16. For example, an area of the outer exposed surface of the middle panel 14 may be prepared for inserting the name and address of sender and the intended recipient of the mailer.

1. A compact disc storage and mailing package comprising a unitary blank defining a pair of generally rectangular end panels each of which is interconnected to a common generally rectangular middle panel through a generally transverse fold line, said middle panel having a pair of laterally opposed side flaps secured thereto along fold lines enabling said flaps to be folded inwardly in overlying relation with the middle panel, said flaps each having a free edge configured to lie in laterally spaced relation with each other and define lateral boundaries of a disc receiving pocket when said flaps are disposed in overlying relation with said middle boundary, one of said end panels being foldable about its transverse fold line to overlie said middle panel and said inwardly folded side flaps and establish a boundary surface and open end for the disc receiving pocket, means for securing lateral marginal edges of said one end panel to said flaps when disposed in said overlying relation, the other of said end panels being foldable about its transverse fold line and sized to overlie and close said disc receiving pocket, and means for releasably securing said other end panel in closed relation with said disc receiving pocket.

2. A compact disc storage and mailing package as defined in claim 1 wherein said one of said end panels has an opening therethrough enabling observation of a compact disc disposed within said disc receiving pocket when said one of said end panels is disposed in overlying relation to said middle panel.

3. A compact disc storage and mailing package as defined in claim 2 wherein said opening in said one of said end panels is circular and of sufficient size to enable identification of indicia disposed generally centrally on a disc disposed within said disc receiving pocket.

4. Wherein said means for securing lateral marginal edges of said one end panel to said flaps includes double sided tape interposed between said side flaps and lateral marginal edges of said one of said end panels.

5. A compact disc storage and mailing package as defined in claim 1 wherein said means for releasably securing said other end panel in closed relation with said disc receiving pocket includes an adhesive formed transversely on a free end of said other end panel, said adhesive having a removable cover thereon adapted to be removed to expose said adhesive when folding said other end panel to its closed relation with said disc receiving pocket.

6. A compact disc storage and mailing package as defined in claim 5 wherein said adhesive is formed on a portion of said other end panel that is interconnected to the remainder of said other end panel by a transverse perforation line that enables said adhesive portion to be severed and thereby enable opening of said other end panel from its closed relation with said disc receiving pocket.

7. A compact disc storage and mailing package as defined in claim 6 wherein said other end panel defines a closure tab having a marginal edge coincident with said transverse perforation line such that when the adhesive portion of said other end panel is removed by severing along said perforation line the tab is exposed and is insertable into a pre-cut slot formed in said one of said end panels that overlies said disc receiving pocket thus enabling said other end panel to be releasably secured in overlying closed relation with said one of said end panels.

8. A compact disc storage and mailing package wherein said unitary blank is made of a relatively stiff paper board.

9. A compact disc storage and mailing package as defined in claim 8 wherein said paper board comprises a cardboard material having an outer surface on which a coating is formed.

10. A compact disc storage and mailing package as defined in claim 1 wherein said middle panel has indicia printed thereon for identifying a sender and an addressee thereon.

11. A compact disc storage and mailing package as defined in claim 10 wherein said indicia further includes indicia for indicating placement of postage stamps for mailing the storage and mailing package with a compact disc disposed within said disc receiving pocket.

12. A compact disc storage and mailing package as defined in claim 1 in combination with a see-through generally rectangular disc cover adapted to receive a disc prior to insertion of the disc and disc cover into the disc receiving pocket of the package.
